(19) United States
(12) Patent Application Publication
(10) Pub. No.: US 2013/0249780 A1
(43) Pub. Date: Sep. 26, 2013

(54) PROJECTION DISPLAY AND LACK OF BRIGHTNESS UNIFORMITY COMPENSATION METHOD

(71) Applicants: Kenji Ishida, Tokyo (JP); Tsutomu Katou, Tokyo (JP); Tooru Kataoka, Tokyo (JP)

(72) Inventors: Kenji Ishida, Tokyo (JP); Tsutomu Katou, Tokyo (JP); Tooru Kataoka, Tokyo (JP)

(21) Appl. No.: 13/991,411

(22) PCT Filed: Jan. 1, 2011
(86) PCT No.: PCT/JP2011/050282

§ 371 Date: Jun. 3, 2013

(51) Int. Cl. G09G 3/20

(52) U.S. Cl. CPC G09G 3/2003
USPC 345/88

(57) ABSTRACT

It is an object of the present invention to correct brightness irregularities of color lights. A projection display apparatus includes a light source that emits light, DMs that divide the light emitted from the light source into a plurality of color lights, LCDs associated respectively with the color lights separated by the separating means, for modulating the color lights depending on an image signal, an XDP that combines the color lights modulated respectively by the LCDs, and a projection lens that projects light combined by the XDP. The projection display apparatus holds correction values for correcting brightness irregularities of the color lights which are caused by the prism. In response to the image signal received thereby, the projection display apparatus determines a plurality of brightness correction values to correct the brightness at the right and left ends of the combined light depending on the correction values, and corrects the image signal in order to correct each of the pixels represented by the image signal depending on the brightness correction values.

### FIELD OF THE INVENTION

The present invention relates to a projection display apparatus and a brightness irregularity correcting method.

### BACKGROUND ART

Projectors are known as display devices for projecting images onto a screen.

FIG. 1 is a diagram showing a configurational example of a display unit for use in a projector. FIG. 1 shows light source 710, dichroic mirrors (hereinafter referred to as “DM”) 721 through 724, total reflection mirrors 731, 732, LCDs (Liquid Crystal Displays) 741 through 743, cross-dichroic prism (hereinafter referred to as “XDP”) 750, and projection lens 760.

FIG. 2a shows a transmittance characteristic of light transmitted through DM 721. FIG. 2b shows a transmittance characteristic of light transmitted through DM 722. FIG. 2c shows a transmittance characteristic of light transmitted through DM 723. FIG. 2d shows a transmittance characteristic of light transmitted through DM 724. FIG. 2e shows a transmittance characteristic of red light transmitted through XDP 750. FIG. 2f shows a transmittance characteristic of blue light transmitted through XDP 750. FIG. 2g shows a wavelength characteristic of blue light reflected by DM 722. FIG. 2h shows a wavelength characteristic of green light reflected by DM 723. FIG. 2i shows a wavelength characteristic of red light reflected by DM 724.

As shown in FIGS. 2a through 2f, DMs 721 through 724 and XDP 750 have a frequency range (transmissive range) in which light is transmitted therethrough, and a frequency range (reflective range) in which light is reflected thereby. The wavelength at the boundary between the transmissive range and the reflective range is referred to as a cutoff wavelength.

In the projector, light emitted from light source 710 does not have a uniform wavelength-dependent intensity distribution, but has peaks at certain wavelengths of red, green, and blue colors. Since the light emitted from light source 710 is not parallel-ray light, it is applied to DMs 721 through 724 and XDP 750 with its transverse cross section becoming progressively wider or narrower. The parallel-ray light refers to light whose rays travel parallel to each other across the transverse cross section thereof.

FIG. 3 is a diagram showing the path of light applied to a DM with its transverse cross section becoming progressively narrower. As shown in FIG. 3, even though the light is applied to section B of the DM at an incident angle θ of 45 degrees, it is applied to section A thereof at an incident angle θ greater than 45 degrees and to section C thereof at an incident angle θ smaller than 45 degrees. When the incident angle of light changes, the transmittance characteristic of the light transmitted through DMs 721 through 724 and XDP 750 changes.

FIG. 4 is a diagram showing the relationship between the incident angle θ and the transmittance characteristic with respect to DM 724.

As shown in FIG. 4, the transmittance characteristic of light transmitted through DM 724 is such that as the incident angle θ becomes greater than 45 degrees, the cutoff wavelength shifts into a longer wavelength range, and as the incident angle θ becomes smaller than 45 degrees, the cutoff wavelength shifts into a shorter wavelength range.

Therefore, in section A of DM 724, since the incident angle of light is greater than 45 degrees, the cutoff wavelength is longer than the cutoff wavelength in section B of DM 724. In section C of DM 745, since the incident angle of light is smaller than 45 degrees, the cutoff wavelength is shorter than the cutoff wavelength in section B of DM 724. If the transverse cross section of light becomes progressively wider, then as the incident angle becomes greater or smaller than 45 degrees, the cutoff frequency shifts into a wavelength range that is opposite to the wavelength range described above.

FIG. 5 is a diagram showing by way of example shifts of the cutoff wavelength in a projector. In FIG. 5, the cutoff wavelength undergoes a shift of 10 nm (nanometers) in DMs 721 through 724. In DM 724, for example, section B separates the wavelengths ranging from 590 nm to 750 nm, section A separates the wavelengths ranging from 600 nm to 760 nm, and section C separates the wavelengths ranging from 580 nm to 740 nm.

Consequently, in each of DMs 721 through 724 and XDP 750, the frequency range of separated light varies depending on the location where the light is applied. Inasmuch as the light emitted from light source 710 does not have a uniform wavelength-dependent intensity distribution, the brightness of the projected image tends to vary.

The human eye has characteristics such that it senses a wavelength in the vicinity of a green color, i.e., 520 nm, as bright, and senses wavelengths in the vicinity of red and blue colors as dark Therefore, red light reflected by section A of DM 724 has a longer wavelength than green light reflected by section B thereof and hence is perceived as dark by the human eye. Red light reflected by section C of DM 724 has a closer wavelength to green light reflected by section B and hence is perceived as bright by the human eye. Blue light and red light are also similarly perceived by the human eye.

FIG. 6 is a diagram showing brightness irregularities of red and blue images which are caused because light emitted from a light source is not parallel-ray light. As shown in FIG. 6, the red and blue images have uneven brightness levels in left, central, and right regions thereof, and hence suffer brightness irregularities.

Patent document 1 discloses a projector which is capable of reducing color irregularities. The projector disclosed in Patent document 1 includes a plurality of light sources, a modulator for modulating lights emitted from the respective light sources, a prism for combining the lights modulated by the modulator, a projection lens for projecting the combined light from the prism, temperature detectors for detecting the temperatures of the light sources, and a memory for storing the respective temperatures of the light sources and brightness distributions of the color lights from the light sources.

The projector disclosed in Patent document 1 controls the modulator to uniformize the brightness distributions of the color lights on a screen based on the temperatures of the light sources which are detected by the temperature detectors and the brightness distributions of the color lights which are stored in memory, to thereby reduce color irregularities that are caused by a change in the temperatures of the light sources.

### PRIOR TECHNICAL DOCUMENTS

### Patent Documents

Patent document 1: JP2004-226631A

### SUMMARY OF THE INVENTION:

### Problems to be Solved by the Invention

The projector disclosed in Patent document 1 has been problematic in that although it can reduce color irregularities due to a change in the temperatures of the light sources, it is unable to reduce brightness irregularities of the respective color lights that result from different light paths in prisms to which the color lights are applied.

A multi-screen display system combines different images generated by a plurality of projectors into a signal image and projects the single image. The multi-screen display system tends to have the image brightness change significantly due to brightness irregularities of color lights at the junctions between the combined images in the projected image.

It is an object of the present invention to provide a projection display apparatus and a brightness irregularity correcting method which correct brightness irregularities of color lights.

### Means for Solving the Problems

According to the present invention, there is provided a projection display apparatus comprising a light source that emits light, separating means that divides the light emitted from said light source into a plurality of color lights, modulators associated respectively with the color lights separated by said separating means, for modulating the color lights depending on an image signal, a prism that combines the color lights modulated respectively by said modulators, a projection lens that projects a which is combined by said prism, holding means that holds correction values for correcting brightness irregularities of the color lights which are caused by said prism, and correcting means that, in response to the image signal received thereby, determines a plurality of brightness correction values for correcting the brightnesses at right and left ends of the combined light depending on the correction values held by said holding means, and that corrects said image signal in order to correct each of the pixels represented by said image signal depending on said brightness correction values.

According to the present invention, there is also provided a brightness irregularity correcting method for a projection display apparatus including a light source that emits light, separating means that divides the light emitted from said light source into a plurality of color lights, modulators associated respectively with the color lights separated by said separating means, for modulating the color lights depending on an image signal, a prism that combines the color lights modulated respectively by said modulators, and a projection lens that projects light combined by said prism, said brightness irregularity correcting method comprising holding correction values for correcting brightness irregularities of the color lights which are caused by said prism, in holding means, and in response to the image signal, determining a plurality of brightness correction values for correcting the brightnesses at right and left ends of the combined light depending on the correction values held by said holding means, and correcting said image signal in order to correct each of pixels represented by said image signal depending on said brightness correction values.

### Advantages of the Invention

According to the present invention, it is possible to correct brightness irregularities of color lights.

### BRIEF DESCRIPTION OF THE DRAWINGS

FIG. 1 is a diagram showing a configurational example of a display unit for use in a projector;

FIG. 2a is a diagram showing a transmittance characteristic of light transmitted through DM 721;

FIG. 2b is a diagram showing a transmittance characteristic of light transmitted through DM 722;

FIG. 2c is a diagram showing a transmittance characteristic of light transmitted through DM 723;

FIG. 2d is a diagram showing a transmittance characteristic of light transmitted through DM 724;

FIG. 2e is a diagram showing a transmittance characteristic of red light transmitted through XDP 750;

FIG. 2f is a diagram showing a transmittance characteristic of blue light transmitted through XDP 750;

FIG. 2g is a diagram showing a wavelength characteristic of blue light reflected by DM 722;

FIG. 2h is a diagram showing a wavelength characteristic of green light reflected by DM 723;

FIG. 2i is a diagram showing a wavelength characteristic of red light reflected by DM 724;

FIG. 3 is a diagram showing the path of light, which is not a parallel light ray, applied to a DM;

FIG. 4 is a diagram showing the relationship between the incident angle and the transmittance characteristic with respect to a DM;

FIG. 5 is a diagram showing by way of example shifts of the cutoff wavelength in a projector;

FIG. 6 is a diagram showing brightness irregularities of red and blue images;

FIG. 7 is a view showing a multi-screen display system according to a first exemplary embodiment of the present invention;

FIG. 8 is a block diagram of projector 1 according to the present exemplary embodiment;

FIG. 9 is a diagram showing a detailed configurational example of display unit 50;

FIG. 10 is a block diagram showing a configurational example of brightness corrector 40;

FIG. 11 is a diagram illustrative of a calculating process carried out by correction value calculator 421;

FIG. 12 is a conceptual diagram showing red images to be corrected;

FIG. 13 is a view showing a menu screen for setting a correction value for the left end of the red image;

FIG. 14 is a diagram showing a brightness correction value set to “−4”;

FIG. 15 is a conceptual diagram showing a blue image to be corrected;

FIG. 16 is a view showing a menu screen for setting a correction value for the left end of the blue image;

FIG. 17 is a diagram showing a brightness correction value set to “+4”;

FIG. 18 is a diagram showing a red image produced when a process for correcting brightness irregularity is performed on an image signal having a maximum level;

FIG. 19 is a diagram showing a red image produced when the level of an image signal is lowered depending on correction value Ar;

FIG. 20 is a diagram showing a blue image produced when a process for correcting brightness irregularity is performed on an image signal having a maximum level;

FIG. 21 is a diagram showing a blue image produced when the level of an image signal is lowered depending on correction value Ab;

FIG. 22 is a flowchart showing a method for correcting brightness irregularity in the multi-screen display system;

FIG. 23 is a view showing an example in which a projector according to a second exemplary embodiment is used;

FIG. 24 is a flowchart showing a method for correcting brightness irregularity in the projector;

FIG. 25 is a diagram showing brightness correction values for a green image whose both side regions are darker than a central region of the image;

FIG. 26 is a diagram showing brightness correction values for a green image whose both side regions are brighter than a central region of the image; and

FIG. 27 is a diagram showing brightness correction values for a green image which are to be acquired using a lookup table.

### MODE FOR CARRYING OUT THE INVENTION

Exemplary embodiments of the present invention will be described below with reference to the drawings.

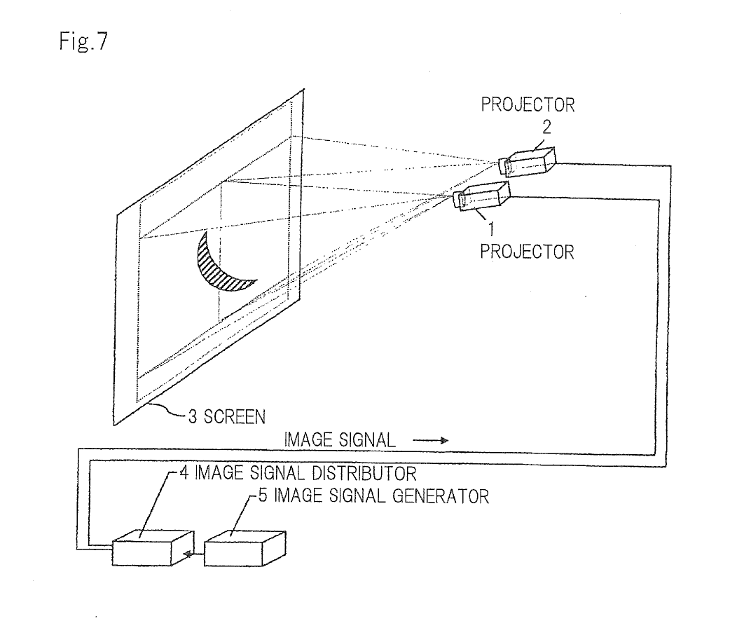

FIG. 7 is a view showing a multi-screen display system according to a first exemplary embodiment of the present invention.

The multi-screen display system joins different images produced by projectors 1, 2 into a single image and projects the single images onto screen 3. The multi-screen display system includes projectors 1, 2, image signal distributor 4, and image signal generator 5. Projectors 1, 2 are identical in structure to each other.

Image signal generator 5 generates an image signal for displaying a crescent at the center of the image, and supplies the image signal to image signal distributor 4.

When image signal distributor 4 receives the image signal, it generates two image signals each identical to the supplied image signal. Image signal distributor 4 supplies one of the two image signals to projector 1 and the other to projector 2.

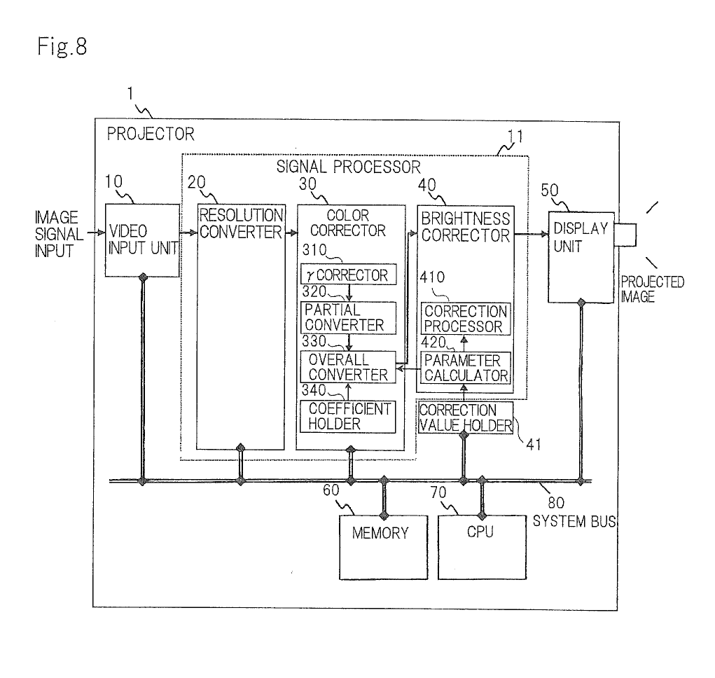

FIG. 8 is a block diagram showing a configurational example of projector 1.

Projector 1 is a projection display apparatus which, in response to an image signal representing an image, projects the image represented by the image signal onto screen 3.

Projector 1 includes video input unit 10, signal processor 11, correction value holder 41, display unit 50, memory 60, and CPU (Central Processing Unit) 70. Signal processor 11 has resolution converter 20, color corrector 30, and brightness corrector 40.

Video input unit 10, resolution converter 20, color corrector 30, correction value holder 41, display unit 50, and memory 60 are connected to CPU 70 by system bus 80. System bus 80 comprises a serial bus or a parallel bus.

CPU 70 controls video input unit 10, resolution converter 20, color corrector 30, color corrector 30, brightness corrector 40, display unit 50, and memory 60. Memory 60 comprises a RAM and a ROM, for example.

Display unit 50 projects an image represented by an image signal from signal processor 11 onto screen 3.

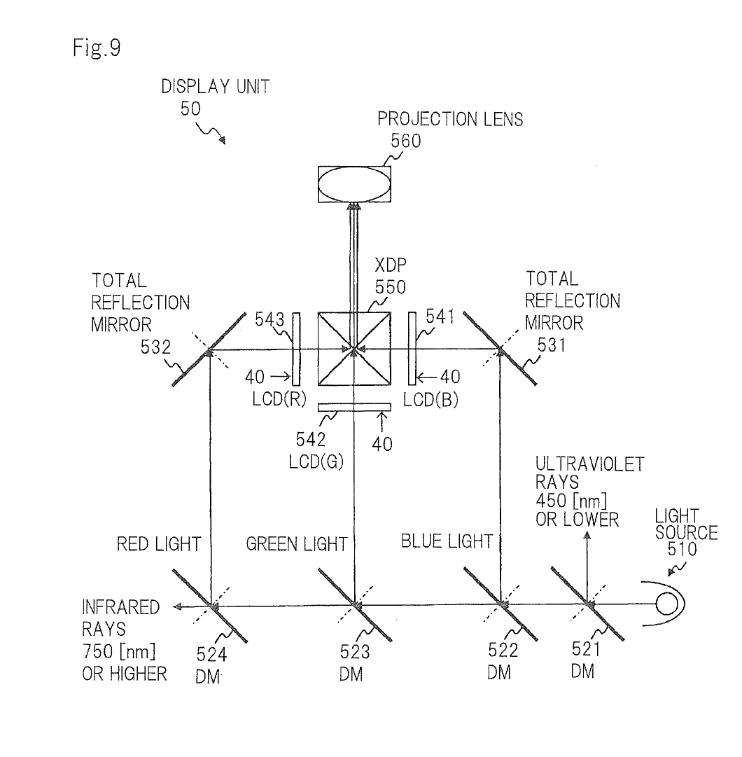

FIG. 9 is a diagram showing a detailed configurational example of display unit 50.

Display unit 50 includes light source 510, DMs 521 through 524, total reflection mirrors 531, 532, LCDs 541 through 543, XDP 550, and projection lens 560.

Light source 510 generates white light. Light source 510 applies the white light to DM 521.

DMs 521 through 524 may generally be referred to as separating means.

DMs 521 through 524 are used to divide the light emitted from light source 510 into blue, green, and red lights. Specifically, DM 521 divides the light emitted from light source 510 into light having a wavelength of 450 nm or higher. DM 522 separates blue light from the light that has passed through DM 521. DM 523 separates green light from the light that has passed through DM 522. DM 524 separates red light from the light that has passed through DM 523.

Total reflection minor 531 applies the blue light separated by DM 522 to LCD 541. Total reflection mirror 532 applies the red light separated by DM 524 to LCD 543.

Each of LCDs 541 through 543 may generally be referred to as a modulator.

LCDs 541 through 543 are provided respectively for the color lights separated by DMs 521 through 524. LCDs 541 through 543 modulate the color lights with respective image signals from brightness corrector 40. Specifically, LCD 541 modulates the blue light from total reflection mirror 531 with a blue image signal. LCD 542 modulates the green light from DM 523 with a green image signal. LCD 543 modulates the red light from total reflection mirror 532 with a red image signal.

XDP 550 may generally be referred to as a prism.

XDP 550 combines the color lights modulated by LCDs 541 through 543. The light combined by XDP 550 (hereinafter referred to as “combined light”) is applied to projection lens 56. DMs 521 through 524 and XDP 550 have characteristics such that they change the transmittance characteristic of light depending on the incident angle at which the light is applied thereto.

Projection lens 560 projects an image represented by the combined light from XDP 550 onto screen 3. According to the present exemplary embodiment, the image projected onto screen 3 will be called a projected image.

In display unit 50, since the light emitted from light source 510 is not parallel light ray, the incident angle at which the light is applied to each of DMs 521 though 524 and XDP 550 changes depending on the different paths of light along which the light is applied thereto. Therefore, the color light divided by each of DMs 521 though 524 and XDP 550 contains a mixture of lights in different frequency ranges, and tends to suffer brightness irregularities.

Correction value holder 41 may generally be referred to as a holding means.

Correction value holder 41 holds correction values A for correcting brightness irregularities of color lights which are caused by DMs 521 though 524 and XDP 550.

Correction values A are set by the user of projector 1 while a white image, i.e., an image which is entirely indicative of white, for example, is projected from projector 1.

According to the present exemplary embodiment, correction value holder 41 holds correction value Ar for red and correction value Ab for blue. Correction value holder 41 may also hold correction value Ag for green.

Video input unit 10 receives an analog image signal from image signal distributor 4. Video input unit 10 converts the received analog image signal into a digital image signal, and supplies the digital image signal to signal processor 11.

Signal processor 11 may generally be referred to as a correcting means.

When signal processor 11 receives an image signal from video input unit 10, it determines a plurality of brightness correction values a(x) for correcting the brightnesses at right and left ends of combined light. For example, signal processor 11 multiplies the distance between each pixel x represented by the image signal and a reference pixel at the left end by correction value A, thereby determining brightness correction value a(x). Signal processor 11 corrects the image signal so that each pixel x represented by the image signal will be corrected depending on brightness correction value a(x).

When resolution converter 20 receives an image signal from video input unit 10, it converts the resolution of an image represented by the image signal into a resolution used by projector 1. Resolution converter 20 also performs a trapezoidal correction process for correcting a trapezoidal distortion of the projected screen on the image signal. Resolution converter 20 supplies the corrected image signal to y corrector 310.

Color corrector 30 corrects the colors of the image represented by the image signal. Color corrector 30 includes y corrector 310, partial converter 320, overall converter 330, and coefficient holder 340.

γ corrector 310 processes the image signal to match the gradation characteristics of projector 1.

Partial converter 320 processes the image signal to adjust a particular hue such as a skin color, a red color, or the like.

Overall converter 330 processes the image signal to correct a hue difference due to the individual variability of projector 1. Overall converter 330 corrects altogether input image signals in respective colors including red, blue, and green, using matrix coefficients C11 through C33.

Overall converters 330 converts input image signals Ri1(x, y), Gi1(x, y), Bi1(x, y) into output image signals Ro1(x, y), Go1(x, y), Bo1(x, y) where x represents a horizontal pixel position in the image and y represents a vertical pixel position in the image, according to the following equation (1):

$$( \begin{matrix}{R}_{o 1 ( x , y )} \\ {G}_{o 1 ( x , y )} \\ {B}_{o 1 ( x , y )}\end{matrix} ) = ( \begin{matrix}{C}_{11} & {C}_{21} & {C}_{31} \\ {C}_{12} & {C}_{22} & {C}_{32} \\ {C}_{13} & {C}_{23} & {C}_{33}\end{matrix} ) ( \begin{matrix}{R}_{i 1 ( x , y )} \\ {G}_{i 1 ( x , y )} \\ {B}_{i 1 ( x , y )}\end{matrix} ) \qquad ( 1 )$$

Overall converter 330 receives matrix coefficients C11, C22, C33 for adjusting the levels (amplification gains) of the image signals in the respective colors, among the matrix coefficients C11 through C33, from parameter calculator 420. Overall converter 330 also receives the other matrix coefficients from coefficient holder 340.

Overall converter 330 may convert input image signals Ri1(x, y), Gi1(x, y), Bi1(x, y) into output image signals Ro1(x, y), Go1(x, y), Bo1(x, y) according to the following equation (2):

$$( \begin{matrix}{R}_{o 1 ( x , y )} \\ {G}_{o 1 ( x , y )} \\ {B}_{o 1 ( x , y )}\end{matrix} ) = ( \begin{matrix}{C}_{11} & 0 & 0 \\ 0 & {C}_{22} & 0 \\ 0 & 0 & {C}_{33}\end{matrix} ) ( \begin{matrix}{R}_{i 1 ( x , y )} \\ {G}_{i 1 ( x , y )} \\ {B}_{i 1 ( x , y )}\end{matrix} ) \qquad ( 2 )$$

Brightness corrector 40 performs on the image signal a process for correcting brightness irregularities of the respective color lights which are caused by DMs 521 through 524 and XDP 550.

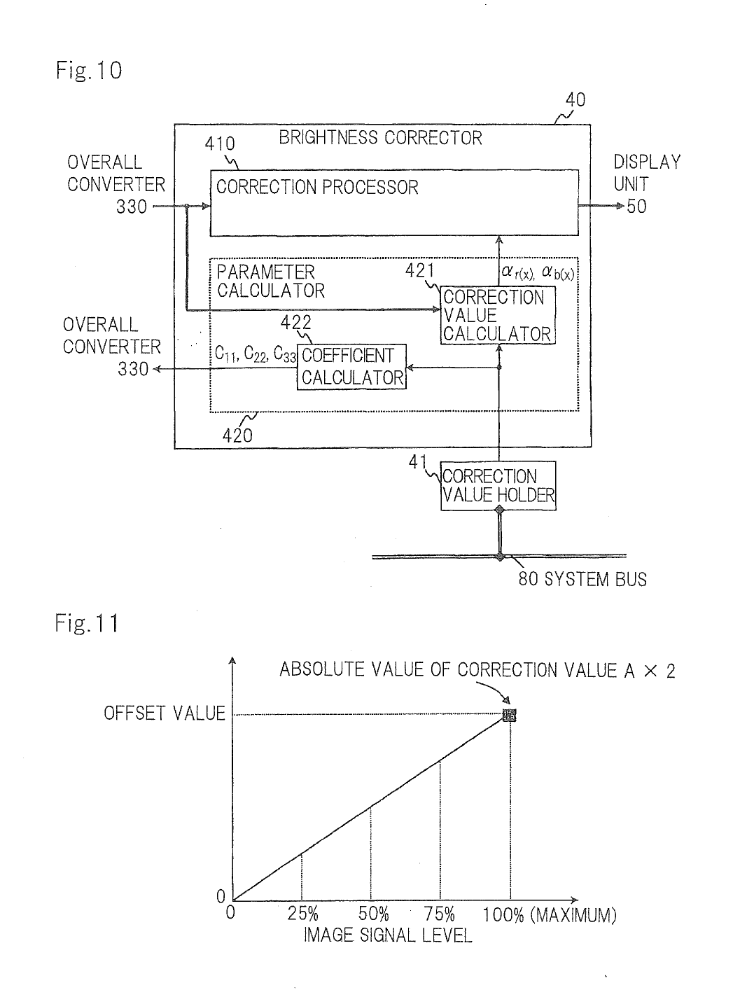

FIG. 10 is a block diagram showing a detailed configuration of brightness corrector 40.

Brightness corrector 40 includes correction processor 410 and parameter calculator 420. Parameter calculator 420 includes correction value calculator 421 and coefficient calculator 422.

Correction value calculator 421 calculates a plurality of brightness correction values for each of the color lights based-on the correction values A held by correction value holder 41 and the levels of the image signals from overall converter 330. Correction value calculator 421 calculates brightness correction values for the pixels at the left end of the projected image using the correction values A while setting the brightness correction value for the central pixel of the projected image to zero, and determines brightness correction values from the left end to the right end of the projected image according to linear interpolation, using the brightness correction values for the pixels at the left end and the central pixel.

According to the present exemplary embodiment, correction value calculator 421 calculates an offset value that defines a gradient for calculating a plurality of brightness correction values, depending on the level of the image signal.

FIG. 11 is a diagram showing the relationship between the level of the image signal and the offset value.

Correction value calculator 421 calculates, as the offset value, a value produced when a value that is twice the absolute value of correction value A is multiplied by the proportion (%) of the level of the image signal.

Correction value calculator 421 calculates a brightness correction value a(x) for the xth pixel from the reference pixel at the left end of the projected image, using the offset value, according to the equation (3) shown below. In other words, correction value calculator 421 determines a brightness correction value a(x) by multiplying the distance x between each pixel represented by the image signal and the reference pixel at the left end, by correction value A.

a(x)=correction coefficient×offset value×distance x−offset value/2 (3)

The correction coefficient is represented by the reciprocal of the number of effective pixels (dots). For XGA, the correction coefficient is 1/1024.

For example, correction value calculator 421 calculates brightness correction value ar(x) for red using correction value Ar for red and the level of the image signal, and calculates a brightness correction value ab(x) for blue using correction value Ab for blue and the level of the image signal.

Coefficient calculator 422 calculates matrix coefficients C11, C22, C33 using correction value A. According to the present exemplary embodiment, coefficient calculator 422 subtracts a maximum value, either the absolute value of correction value Ar or the absolute value of correction value Ab, from given data, and calculates the difference as matrix coefficients C11, C22, C33.

For example, if the image signal is represented by 8 bits, then matrix coefficients C11, C22, C33 are represented by 9 bits. In this case, coefficient calculator 422 calculates matrix coefficients C11, C22, C33 according to the following equation (4):

C11, C22, C33=100000000−maximum value among absolute values of Ar, Ab (4)

If the image signal is represented by 10 bits, then matrix coefficients C11, C22, C33 are represented by 11 bits, and coefficient calculator 422 calculates matrix coefficients C11, C22, C33 according to the following equation (5):

C11, C22, C33=10000000000−maximum value among absolute values of Ar, Ab (5)

Coefficient calculator 422 may subtract a maximum value selected from plural brightness correction values ar(x) or plural brightness correction values ab(x) calculated by correction value calculator 421, from given data to calculate matrix coefficients C11, C22, C33.

Correction processor 410 corrects the image signal in order to correct each of pixels x represented by the image signal depending on brightness correction value a(x). Specifically, correction processor 410 adds brightness correction value a(x) to the image signal if the sign of correction value A is negative (minus), and subtracts correction value a(x) from the image signal if the sign of correction value A is positive (plus).

According to the present exemplary embodiment, correction processor 410 receives brightness correction value ar(x) for red and brightness correction value ab(x) for blue from correction value calculator 421. Correction processor 410 also receives the image signal from overall converter 330.

Correction processor 410 corrects red image signal Ri2(x, y) using the sign of correction value Ar and brightness correction value ar(x), and corrects blue image signal Bi2(x, y) using the sign of correction value Ab and brightness correction value ab(x).

If the sign of correction values Ar, Ab is negative, then correction processor 410 adds brightness correction values ar(x), ab(x) respectively to image signals Ri2(x, y), Bi2(x, y) according to the following equation (6):

$$( \begin{matrix}{R}_{o 2 ( x , y )} \\ {G}_{o 2 ( x , y )} \\ {B}_{o 2 ( x , y )}\end{matrix} ) = ( \begin{matrix}{R}_{i 2 ( x , y )} \\ {G}_{i 2 ( x , y )} \\ {B}_{i 2 ( x , y )}\end{matrix} ) + ( \begin{matrix}{α}_{r ( x )} \\ 0 \\ {α}_{b ( x )}\end{matrix} ) \qquad ( 6 )$$

If the sign of correction values Ar, Ab is positive, then correction processor 410 subtracts brightness correction values ar(x), ab(x) respectively to image signals Ri2(x, y), Bi2(x, y) according to the equation (7) shown below. Therefore, correction processor 410 calculates corrected image signals Ro2(x, y), Go2(x, y), Bo2(x, y).

$$( \begin{matrix}{R}_{o 2 ( x , y )} \\ {G}_{o 2 ( x , y )} \\ {B}_{o 2 ( x , y )}\end{matrix} ) = ( \begin{matrix}{R}_{i 2 ( x , y )} \\ {G}_{i 2 ( x , y )} \\ {B}_{i 2 ( x , y )}\end{matrix} ) - ( \begin{matrix}{α}_{r ( x )} \\ 0 \\ {α}_{b ( x )}\end{matrix} ) \qquad ( 7 )$$

Then, a process of reducing a change in the brightness at the junctions of an image projected by the multi-screen display system will be described below.

In order to correct brightness irregularities of color lights of red and blue, projectors 1, 2 project white images onto screen 3.

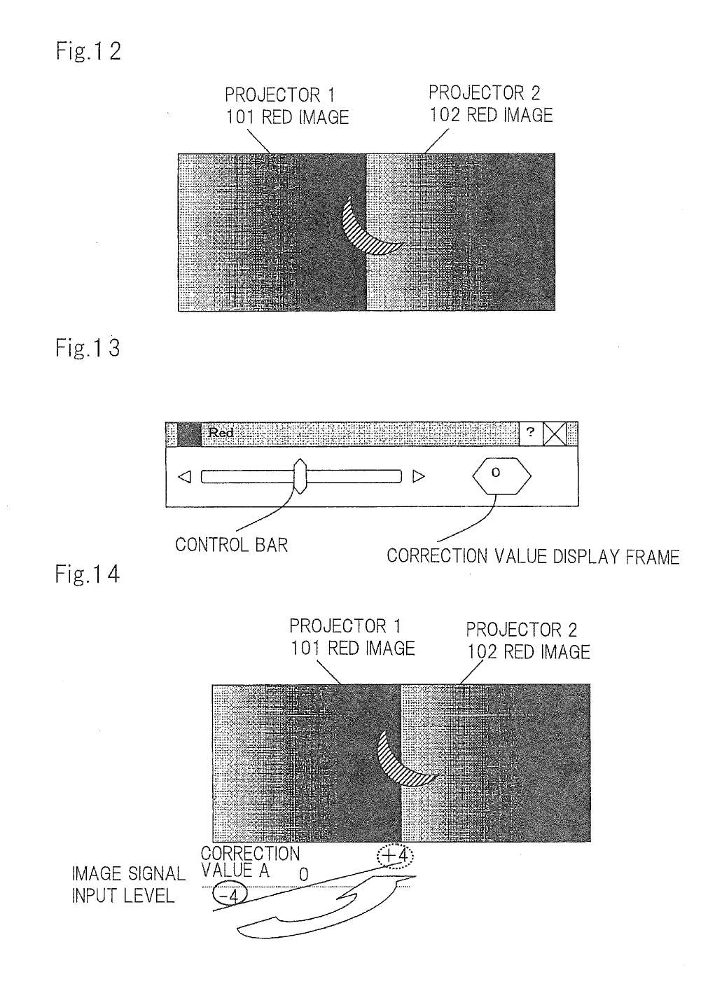

FIG. 12 is a conceptual diagram showing red images to be corrected which are projected from projectors 1, 2. Red image 101 is an image in red which is projected from projector 1. Red image 102 is an image in red which is projected from projector 2.

As shown in FIG. 12, the difference between the brightness at the right end of red image 101 projected by projector 1 and the brightness at the left end of red image 102 projected by projector 2 is so large that the brightness of the overall red images is irregular. The user sets correction value Ar for the brightness irregularity of red image 101 in projector 1.

FIG. 13 shows a menu screen for setting correction value Ar for the left end of the red image. Correction value Ar is set to a value in a range from “−4” to “+4), for example, using a control bar. In order to lower the brightness at the left end of the red image, for example, correction value Ar is set to a minus (−) value.

FIG. 14 is a conceptual diagram showing brightness correction value ar(x) at the time correction value Ar is set to “−4”. As shown in FIG. 14, correction value calculator 421 determines brightness correction value ar(x) so as to keep the brightness of the central pixel of the red image unchanged and to change the brightness linearly from the left end to the right end of the screen. Correction processor 410 processes the image signal according to the equation (6), using the sign (−) of correction value Ar and brightness correction value ar(x), thus adding brightness correction value ar(x) to the red image signal.

Correction of brightness irregularities of a color light of blue with projector 2 will be described below.

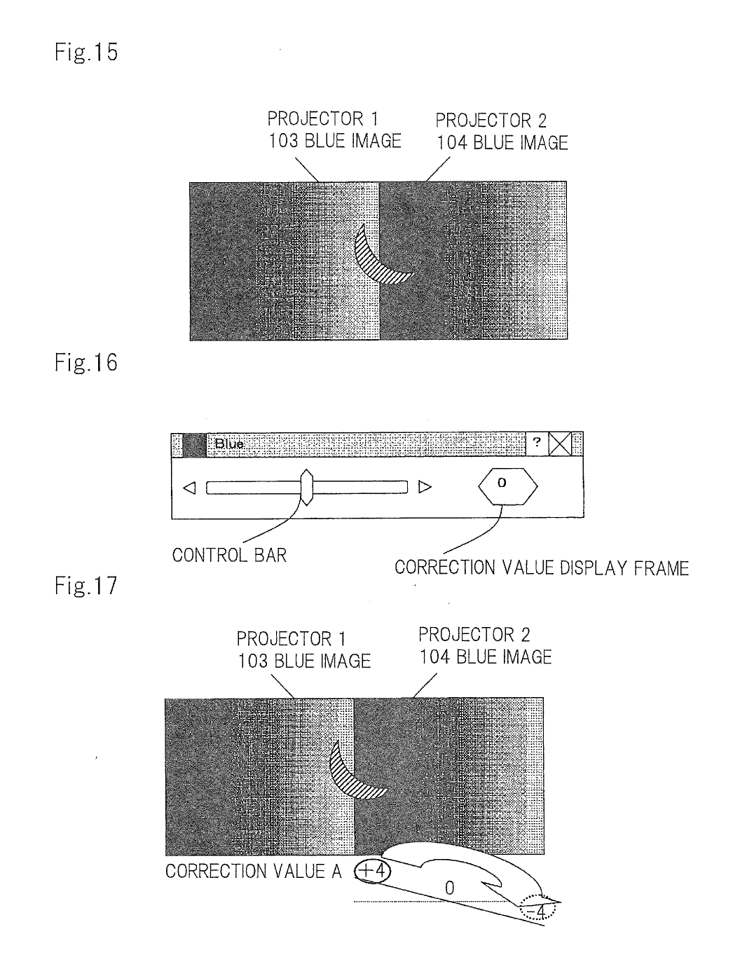

FIG. 15 is a conceptual diagram showing blue images to be corrected which are projected from projectors 1, 2. Blue image 103 is an image in blue which is projected from projector 1. Blue image 104 is an image in blue which is projected from projector 2.

As shown in FIG. 15, the difference between the brightness at the right end of blue image 103 projected by projector 1 and the brightness at the left end of blue image 104 projected by projector 2 is so large that the brightness of the overall blue images is irregular. The user sets correction value Ab for the brightness irregularity of blue image 104 in projector 2.

FIG. 16 shows a menu screen for setting correction value Ab for the left end of the blue image. Correction value Ab is set to a value in a range from “−4” to “+4), for example, using a control bar. In order to raise the brightness at the left end of the blue image, for example, correction value Ab is set to a plus (+) value.

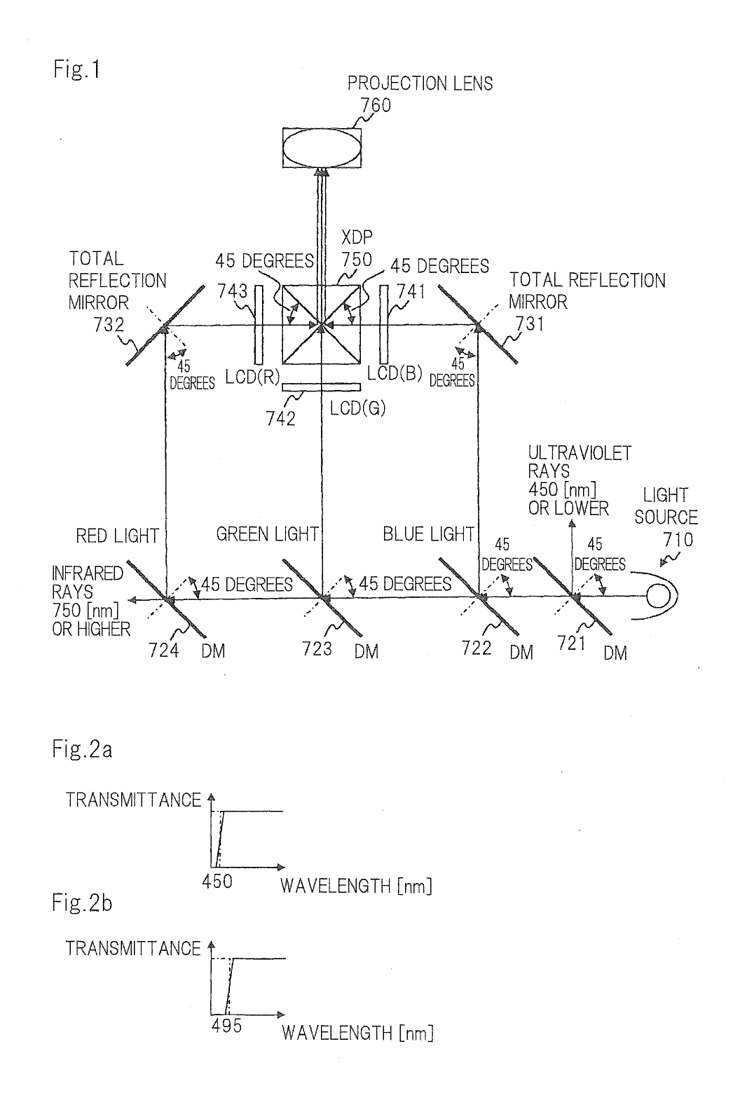

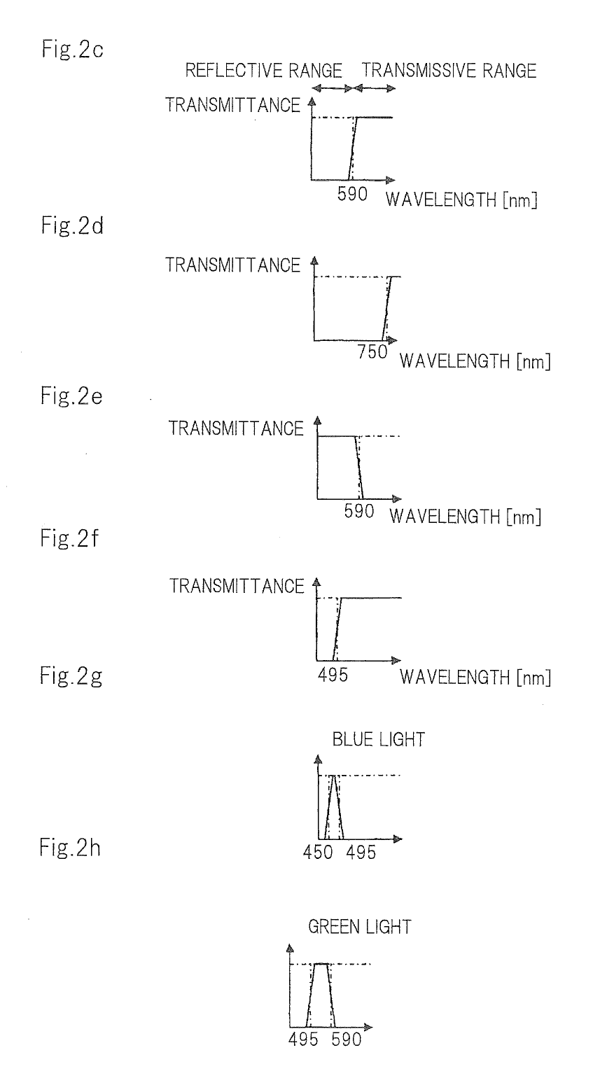

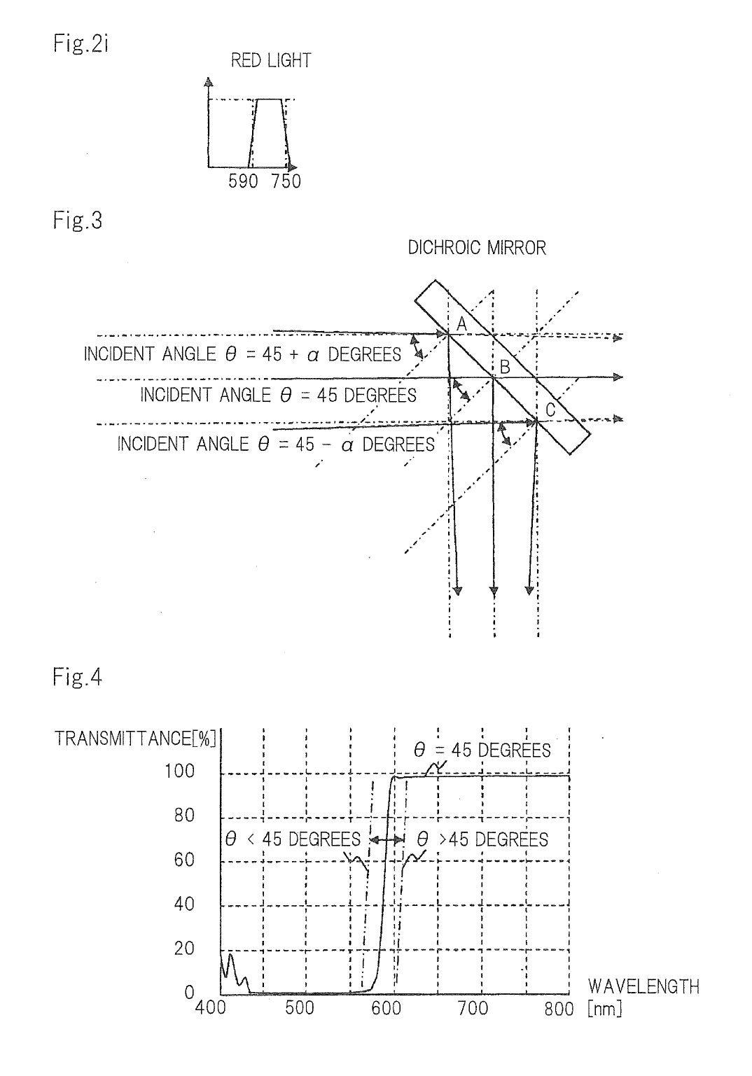

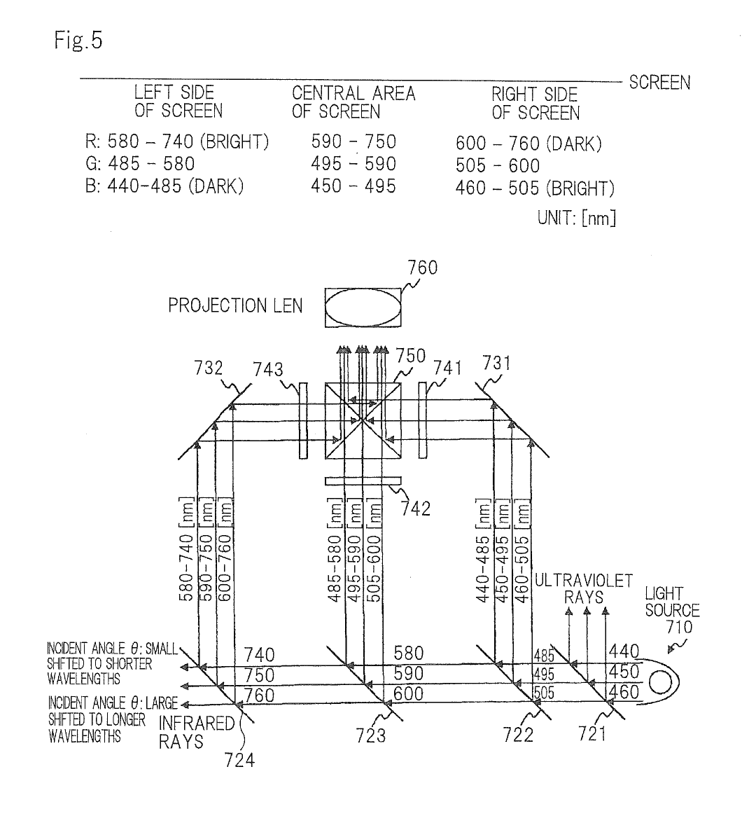

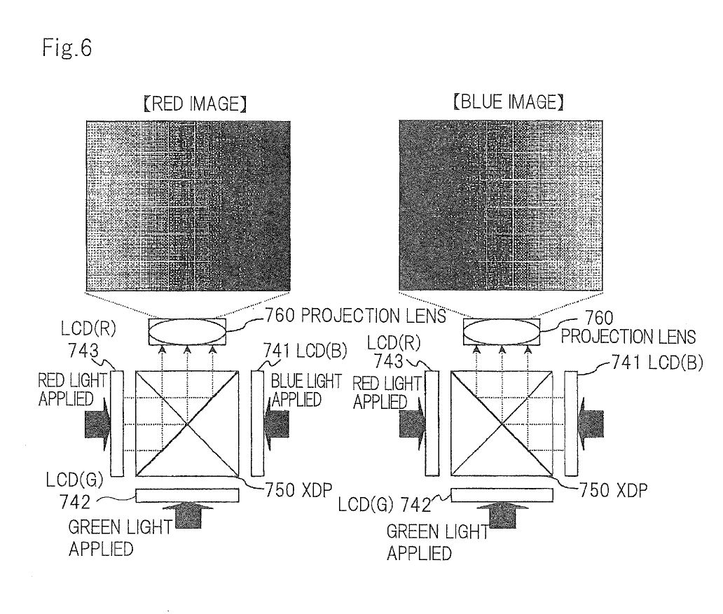

FIG. 1-7 is a conceptual diagram showing brightness correction value ab(x) at the time correction value Ab is set to “+4”. As shown in FIG. 17, correction value calculator 421 determines brightness correction value ab(x) so as to keep the brightness of the central pixel of the blue image unchanged and to change the brightness linearly from the left end to the right end of the screen. Correction processor 410 processes the image signal according to the equation (7), using the sign (+) of correction value Ab and brightness correction value ab(x), thus subtracting brightness correction value ab(x) from the blue image signal.

Therefore, the multi-screen display system is capable of reducing a change in the brightness which appears significantly at the junctions between the images projected from projectors 1, 2. However, when image signals having a maximum level are input to projectors 1, 2, the image signals are clipped by correction processors 410 of projectors 1, 2.

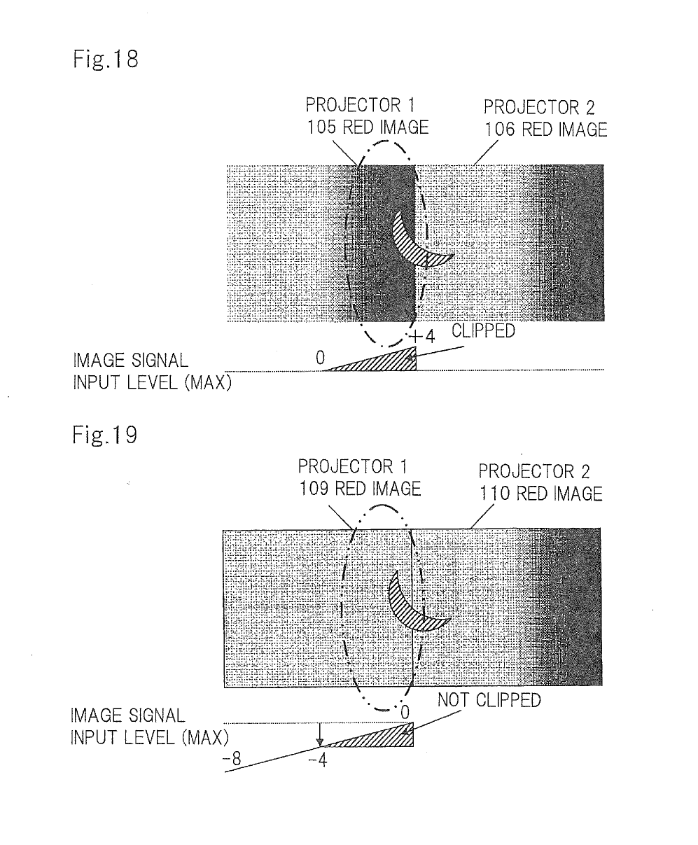

FIG. 18 is a diagram showing a red image produced when a process to correct a brightness irregularity is performed on an image signal having a maximum level. As shown in FIG. 18, the brightness irregularities of red image 105 indicated by the dot and dash lines remain uncorrected because the corrected image signal is clipped.

In projector 1, signal processor 11 lowers the level of the image signal depending on the maximum value of the absolute value of correction value Ar, and corrects the image signal per pixel depending on brightness correction value Ar(x). Specifically, coefficient calculator 422 calculates matrix coefficients C11, C22, C33 according to the equation (4), and overall converter 330 multiplies the red, blue, and green image signals by matrix coefficients C11, C22, C33 which are of the same value, thus simultaneously adjusting the levels (gains) of the image signals of the respective colors. Correction processor 410 then performs a process to correct the brightness irregularity on the adjusted image signals.

FIG. 19 is a diagram showing a red image produced when the level of an image signal is lowered depending on correction value Ar. As shown in FIG. 19, even when an image signal having a maximum level is input, red image 109 indicated by the dot-and-dash lines has its brightness irregularities corrected because the corrected image signal is not clipped.

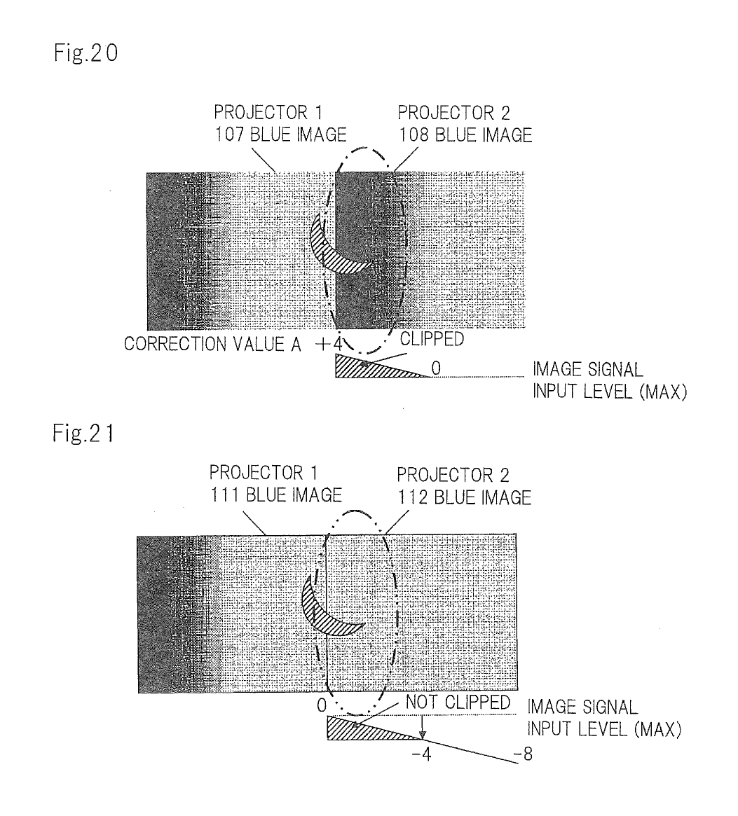

FIG. 20 is a diagram showing a blue image produced when a process to correct brightness irregularity is performed on an image signal having a maximum level. As shown in FIG. 20, blue image 108 indicated by the dot-and-dash lines has its brightness irregularities uncorrected because the corrected image signal is clipped.

In projector 2, signal processor 11 lowers the level of the image signal depending on the maximum value of the absolute value of correction value Ab, and corrects the image signal per pixel depending on brightness correction value ab(x).

FIG. 21 is a diagram showing a blue image produced when the level of an image signal is lowered depending on correction value Ab. As shown in FIG. 21, even when an image signal having a maximum level is input, blue image 112 indicated by the dot-and-dash lines has its brightness irregularities corrected because the corrected image signal is not clipped.

Operation of the multi-image display system will be described below.

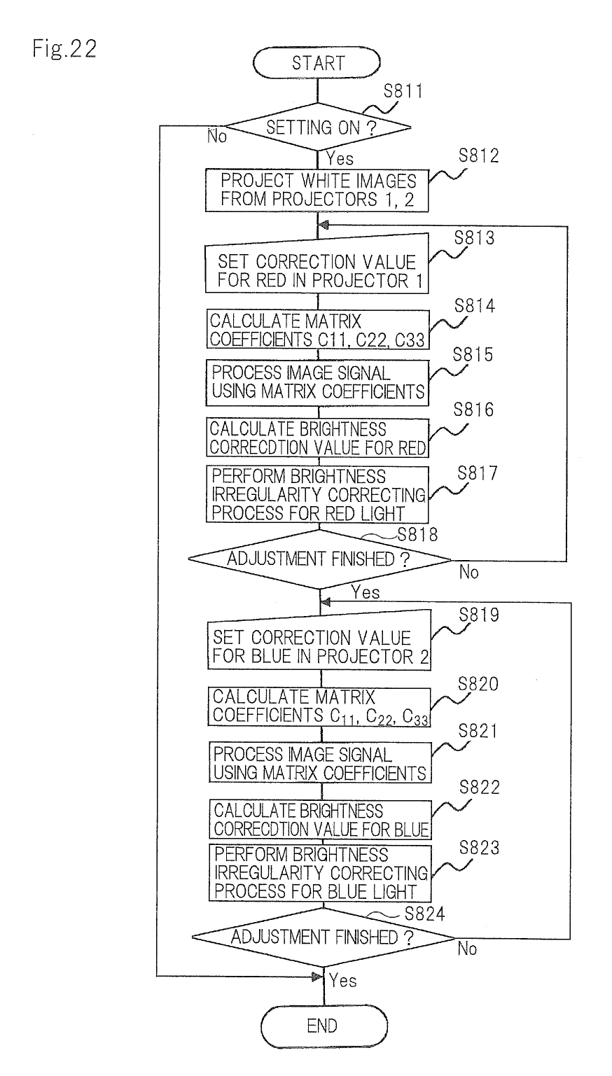

FIG. 22 is a flowchart showing a method for correcting brightness irregularity in the multi-screen display system.

The function in projectors 1,2 that is used to correct brightness irregularity is turned on (step S811), and projectors 1, 2 project white images onto screen 3 (step S812).

While the white images are being projected from projectors 1, 2 onto screen 3, correction value Ar for red is set in projector 1 and held by correction value holder 41 thereof (step S813). When correction value Ar is held by correction value holder 41, coefficient calculator 422 of projector 1 calculates matrix coefficients C11, C22, C33 depending on correction value Ar (step S814).

Thereafter, overall converter 330 of projector 1 processes the image signal according to the equation (1) using the matrix coefficients from coefficient calculator 422 (step S815). In other words, overall converter 330 simultaneously lowers the levels of the red, blue, and green image signals depending on the absolute value of correction value Ar.

Correction value calculator 421 of projector 1 calculates brightness correction value ar(x) for red per pixel using the levels of the image signals from overall converter 330 and correction value Ar (step S816).

Correction processor 410 of projector 1 adds brightness correction value ar(x) to or subtracts brightness correction value ar(x) from the red image signal depending on the sign of correction value Ar (step S817). In other words, correction processor 410 performs a process to correct brightness irregularity for the red light using the sign of correction value Ar and brightness correction value ar(x).

Consequently, brightness corrector 40 determines a plurality of brightness correction values ar(x) to correct the brightnesses at the right end and the left end of the combined light depending on correction value Ar, and corrects the red image signal so as to correct each of the pixels represented by the image signal depending on brightness correction values ar(x).

When adjustment of correction value Ar for red is finished for projector 1 (step S818), correction value Ab for blue is set in projector 2 and held by correction value holder 41 thereof (step S819) while the white images are being projected from projectors 1, 2 onto screen 3 (step S819).

When correction value Ab is held by correction value holder 41, coefficient calculator 422 of projector 2 calculates matrix coefficients C11, C22, C33 depending on correction value Ab (step S820). Thereafter, overall converter 330 of projector 2 processes the image signal according to the equation (1) using the matrix coefficients from coefficient calculator 422 (step S821). In other words, overall converter 330 simultaneously lowers the levels of the image signals of the respective colors depending on the absolute value of correction value Ab.

Correction value calculator 421 of projector 2 calculates brightness correction value ab(x) for blue per pixel using the levels of the image signals from overall converter 330 and correction value Ab (step S822).

Correction processor 410 of projector 2 adds brightness correction value ab(x) to or subtracts brightness correction value ab(x) from the blue image signal depending on the sign of correction value Ab (step S823). In other words, correction processor 410 performs a process to correct brightness irregularity for the blue light using the sign of correction value Ab and brightness correction value ab(x).

Consequently, brightness corrector 40 determines a plurality of brightness correction values ab(x) to correct the brightnesses at the right end and the left end of the combined light depending on correction value Ab, and corrects the blue image signal so as to correct each of the pixels represented by the image signal depending on brightness correction values ab(x).

When the adjustment of correction value Ab for blue is finished for projector 2 (step S824), the method to correct brightness irregularity for the multi-screen display system is finished.

According to the first exemplary embodiment, in projector 1, correction value holder 41 holds correction value Ar for red, and when signal processor 11 receives an image signal, it determines a plurality of brightness correction values ar(x) to correct the brightness at the right and left ends of the projected image (combined light) depending on correction value Ar held by correction value holder 41, and corrects the image signal so as to correct each of the pixels represented by the image signal depending on brightness correction values ar(x). In projector 2, correction value holder 41 holds correction value Ab for blue, and when signal processor 11 receives an image signal, it determines a plurality of brightness correction values ab(x) to correct the brightness at the right and left ends of the projected image (combined light) depending on correction value Ab held by correction value holder 41, and corrects the image signal so as to correct each of the pixels represented by the image signal depending on brightness correction values ab(x).

The multi-screen display system can therefore reduce a change in brightness which appears significantly at the junctions between the images projected from projectors 1, 2 due to brightness irregularities of the respective color lights which are caused by DMs 521 through 524 and XDP 550.

According to the first exemplary embodiment, furthermore, correction value holder 41 holds correction value A for red or blue, and signal processor 11 simultaneously lowers the levels of the image signals of the respective colors depending on correction value A held by correction value holder 41, thereby correcting the image signals depending on brightness correction values a(x).

Therefore, even when signal processor 11 receives an image signal having a maximum level, it can correct the image signal depending on brightness correction values a(x) without clipping the image signal which has been corrected. Accordingly, projectors 1, 2 can appropriately correct brightness irregularities caused by the differences between the paths of the color lights.

According to the first exemplary embodiment, moreover, signal processor 11 multiplies the distance between each pixel x represented by the image signal and a reference pixel at the left end by correction value A, thereby determining brightness correction value a(x), and corrects the image signal per pixel depending on brightness correction value a(x).

Consequently, projectors 1, 2 are capable of correcting a red or blue image signal in accordance with the characteristics of brightness irregularities of the color light which are caused by the difference between the paths of the red and blue lights.

The multi-image display system according to the present exemplary embodiment is illustrated as having two projectors. However, the multi-image display system may have three or more projectors.

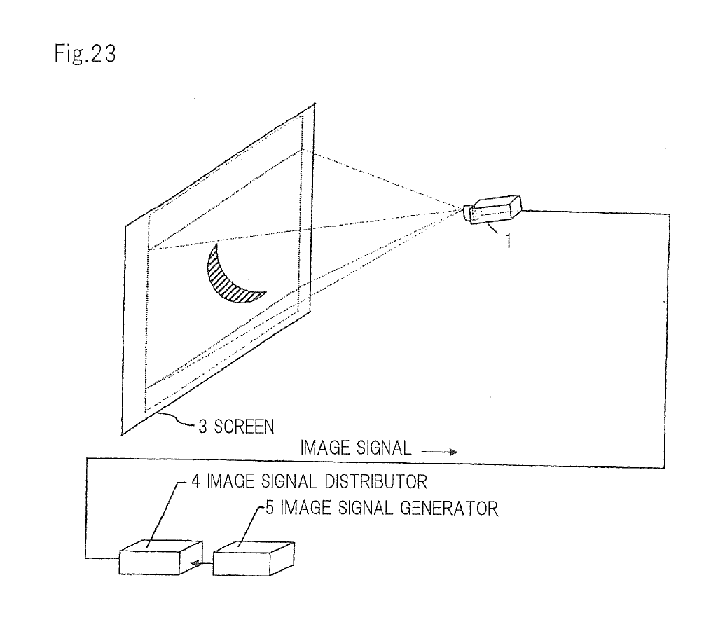

FIG. 23 is a view showing an example in which a projector according to a second exemplary embodiment is used.

Projector 1 receives an image signal from image signal distributor 4, and projects an image of a crescent represented by the image signal onto screen 3.

According to the present exemplary embodiment, while a white image is being projected from projector 1 onto screen 3, correction value Ar for red is set in projector 1 by the control bar shown in FIG. 13. For example, if correction value Ar is set from “0” to “−4” in order to lower the brightness at the left end of the red image, then correction value calculator 421 determines brightness correction value ar(x) so as to keep the brightness of the central pixel of the red image unchanged and to change the brightness linearly from the left end to right end of the screen. Correction processor 410 processes the image signal according to the equation (6) or equation (7), depending on the sign of correction value Ar, thus adding brightness correction value ar(x) to the red image signal.

Then, while the white image is being projected from projector 1 onto screen 3, a correction value is set in projector 1 by the control bar shown in FIG. 16. For example, if the correction value is set from “0” to “+2” in order to raise the brightness at the left end of the blue image, then correction value calculator 421 determines brightness correction value ab(x) so as to keep the brightness of the central pixel of the blue image unchanged and to change the brightness linearly from the left end to the right end of the screen. Correction processor 410 processes the image signal according to equation (6) or equation (7), depending on the sign of correction value Ab, thus adding brightness correction value ab(x) to the blue image signal.

Parameter calculator 420 compares the absolute value of correction value Ar and the absolute value of correction value Ab with each other, and calculates matrix coefficients C11, C22, C33 according to equation (4) using a greater maximum value of the compared values. Parameter calculator 420 may calculate matrix coefficients C11, C22, C33 according to equation (4) using a maximum value among plural brightness correction values ar(x) and plural brightness correction values ab(x).

Overall converter 330 simultaneously lowers the levels of the image signals according to equation (1) using matrix coefficients C11, C22, C33 from parameter calculator 420. Correction processor 410 can thus correct the image signals without clipping the image signals.

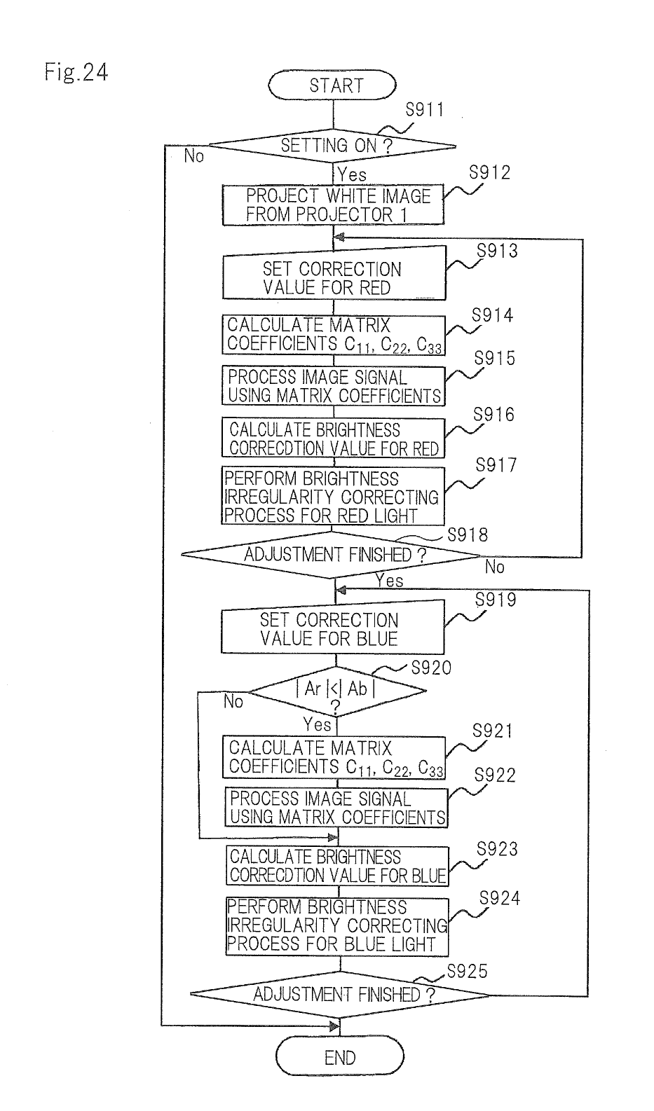

FIG. 24 is a flowchart showing a method for correcting brightness irregularity in the projector 1.

The function in projector 1 that is used to correct brightness irregularity is turned on (step S911), and projector 1 projects a white image onto screen 3 (step S912).

While the white image is being projected from projector 1 onto screen 3, correction value Ar for red is set in projector 1 and held by correction value holder 41 thereof (step S913).

When correction value Ar is held by correction value holder 41, coefficient calculator 422 calculates matrix coefficients C11, C22, C33 depending on correction value Ar (step S914).

Thereafter, overall converter 330 processes the image signal according to equation (1) using the matrix coefficients from coefficient calculator 422 (step S915).

Correction value calculator 421 calculates brightness correction value ar(x) for red per pixel depending on the image signals from overall converter 330 and correction value Ar (step S916). Correction processor 410 adds brightness correction value ar(x) to or subtracts brightness correction value ar(x) from the red image signal depending on the sign of correction value Ar (step S917). In other words, correction processor 410 performs a process to correct brightness irregularity for the red light using the sign of correction value Ar and brightness correction value ar(x).

When the adjustment of correction value Ar for red is finished (step S918), correction value Ab for blue is set in projector 2 and held by correction value holder 41 thereof (step S919) while the white image is being projected from projector 1 onto screen 3 (step S919).

When correction value Ab is held by correction value holder 41, coefficient calculator 422 confirms whether or not the absolute value of correction value Ab for blue is greater than the absolute value of correction value Ar for red (step S920). If the absolute value of correction value Ab is greater than the absolute value of correction value Ar, then coefficient calculator 422 calculates matrix coefficients C11, C22, C33 depending on correction value Ab (step S921).

Thereafter, overall converter 330 processes the image signal according to equation (1) using the matrix coefficients from coefficient calculator 422 (step S922). Correction value calculator 421 calculates brightness correction value ab(x) for blue per pixel depending on the levels of the image signals from overall converter 330 and correction value Ab (step S923).

If the absolute value of correction value Ab is equal to or smaller than the absolute value of correction value Ar in step S920, correction value calculator 421 also calculates brightness correction value ab(x) for blue per pixel (step S923).

Thereafter, correction processor 410 adds brightness correction value ab(x) to or subtracts brightness correction value ab(x) from the blue image signal depending on the sign of correction value Ab (step S924). In other words, correction processor 410 performs a process to correct brightness irregularity for the blue light using the sign of correction value Ar and brightness correction value ab(x).

When the adjustment of correction value Ab for blue is finished (step S925), the method for correcting brightness irregularity is finished.

According to the second exemplary embodiment, correction value holder 41 holds correction value Ar for red and correction value Ab for blue, and when signal processor 11 receives an image signal, it simultaneously lowers the levels of the image signals in the respective colors depending on a maximum value subtracts a maximum value, either the absolute value of correction value Ar or the absolute value of correction value Ab, from given data.

Therefore, projector 1 can prevent image signals in both blue and red colors from being clipped when it corrects these image signals. Consequently, projector 1 is capable of reducing brightness irregularities of both red and blue colors.

According to the first and second exemplary embodiments, the method for correcting brightness irregularity is performed on the red and blue lights. However, it may be performed on the green light. In this case, if the sign of correction value Ag is negative, then correction processor 410 adds brightness correction value ag(x) to the green image signal according to the equation (8) shown below. If the sign of correction value Ag is positive, then correction processor 410 subtracts brightness correction value ag(x) from the green image signal according to the equation (9) shown below.

$$\begin{matrix}( \begin{matrix}{R}_{o 2 ( x , y )} \\ {G}_{o 2 ( x , y )} \\ {B}_{o 2 ( x , y )}\end{matrix} ) = ( \begin{matrix}{R}_{i 2 ( x , y )} \\ {G}_{i 2 ( x , y )} \\ {B}_{i 2 ( x , y )}\end{matrix} ) + ( \begin{matrix}{α}_{r ( x )} \\ {α}_{g ( x )} \\ {α}_{b ( x )}\end{matrix} ) & ( 8 ) \\ ( \begin{matrix}{R}_{o 2 ( x , y )} \\ {G}_{o 2 ( x , y )} \\ {B}_{o 2 ( x , y )}\end{matrix} ) = ( \begin{matrix}{R}_{i 2 ( x , y )} \\ {G}_{i 2 ( x , y )} \\ {B}_{i 2 ( x , y )}\end{matrix} ) - ( \begin{matrix}{α}_{r ( x )} \\ {α}_{g ( x )} \\ {α}_{b ( x )}\end{matrix} ) & ( 9 )\end{matrix}$$

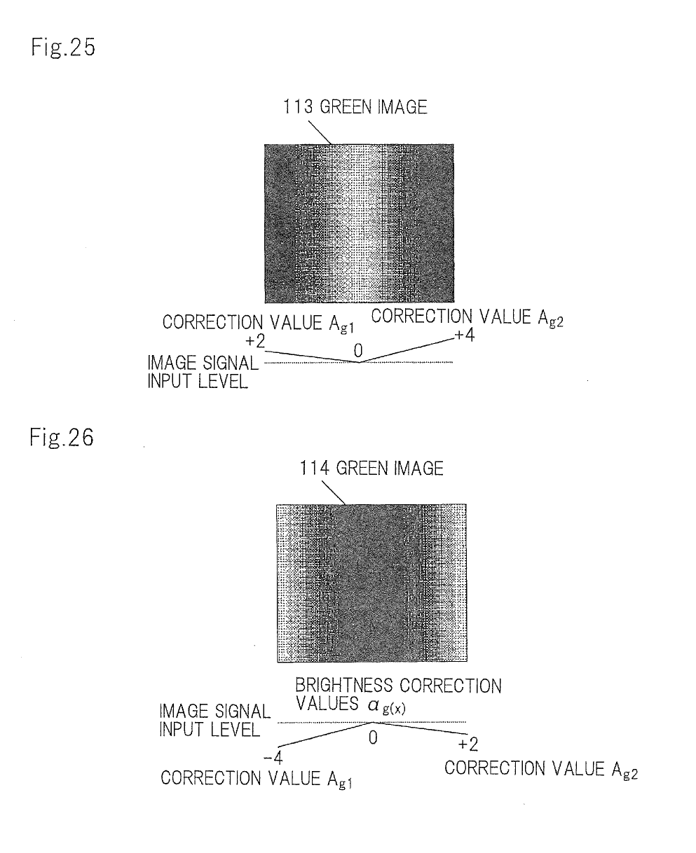

FIGS. 25 and 26 are diagrams showing examples in which brightness correction value ag(x) for green is calculated. With respect to green images, since the human eye perceives a wavelength in the vicinity of 520 nm among wavelengths ranging from 495 to 590 nm, as bright, when the cutoff wavelength is shifted due to the different path of the green light, the central area of the screen and the both ends of the screen look different in terms of brightness. However, the difference in brightness (brightness irregularity) between the central area of the screen and the both ends of the screen is smaller than the difference in brightness on red and blue images.

For example, green image 113 shown in FIG. 25 has both screen sides darker than the central area of the screen. Alternatively, green image 114 shown in FIG. 26 has both screen sides brighter than the central area of the screen.

Therefore, in order to perform a process to correct brightness irregularity for green light, correction value Ag1 for the left end of the screen and correction value Ag2 for the right end of the screen should preferably be settable independently, and correction calculator 421 should preferably calculate brightness correction values ag(x) individually for the left end and the right end of the screen, using correction value Ag1 and correction value Ag2 for both ends of the screen. Correction value Ag1 for green and correction value Ag2 for green are called first and second green correction values, respectively.

Specifically, signal processor 11 determines left brightness correction value ag1(x) by multiplying the distance between each pixel on the left side of a central pixel and the central pixel by corrective value Ag1. Signal processor 11 determines right brightness correction value ag2(x) by multiplying the distance between each pixel on the right side of a central pixel and the central pixel by corrective value Ag2. Signal processor 11 then corrects the green image signal depending on rightness correction value ag1(x) and brightness correction value ag2(x).

Therefore, it is possible to appropriately correct brightness irregularities of green image 113 shown in FIG. 25 or green image 114 shown in FIG. 26.

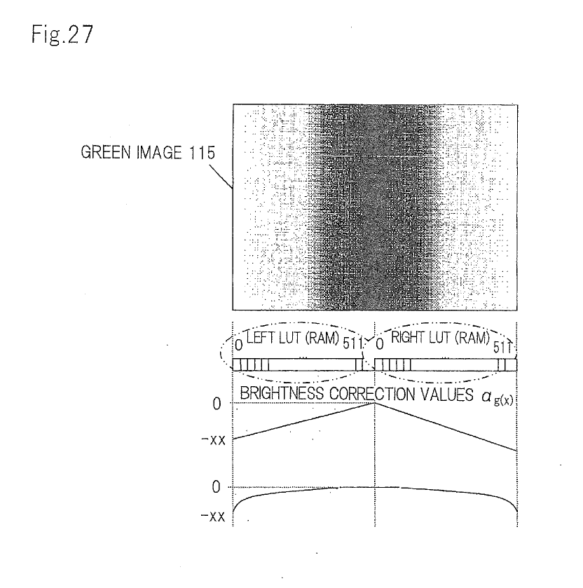

FIG. 27 is a diagram showing another example in which brightness correction values ag(x) are calculated. In FIG. 27, a lookup table containing brightness correction values ag(x) associated with respective pixels is stored in memory 60. Correction value calculator 421 acquires brightness correction values ag(x) from the lookup table. Projector 1 is thus able to make brightness correction values ag(x) curvilinear in the central area of the screen, unlike FIGS. 25 and 26, making it possible to correct green image 115 more appropriately.

The configurations illustrated in the exemplary embodiments described above are shown by way of example only, and the present invention is not limited to the illustrated configurations.

### DESCRIPTION OF REFERENCE CHARACTERS

1, 2 projector

3 screen

4 image signal distributor

5 image signal generator

10 video input unit

11 signal processor

20 resolution converter

30 color corrector

310 γ corrector

320 partial converter

330 overall converter

340 coefficient holder

40 brightness corrector

41 correction value holder

410 correction processor

420 parameter calculator

421 correction value calculator

422 coefficient calculator

50 display unit

510 light source

521-524 DM

531, 532 total reflection mirror

541-543 LCD

550 XDP

560 projection lens

60 memory

70 CPU

1. A projection display apparatus comprising:
a light source that emits light;
separating means that divides the light emitted from said light source into a plurality of color lights;
modulators associated respectively with the color lights separated by said separating means, for modulating the color lights depending on an image signal;
a prism that combines the color lights modulated respectively by said modulators;
a projection lens that projects light combined by said prism;
holding means that holds correction values for correcting brightness irregularities of the color lights which are caused by said prism; and
correcting means that, in response to the image signal received thereby, determines a plurality of brightness correction values to correct the brightnesses at right and left ends of the combined light depending on the correction values held by said holding means, and corrects said image signal in order to correct each of pixels represented by said image signal depending on said brightness correction values.

2. The projection display apparatus according to claim 1, wherein said holding means holds a correction value for red and a correction value for blue; and
said correcting means lowers the level of said image signal depending on a maximum value among the absolute values of the correction values held by said holding means, and corrects said image signal depending on said brightness correction values with respect to each of the correction values.

3. The projection display apparatus according to claim 2, wherein said correcting means determines said brightness correction values by multiplying the distance between each of pixels represented by said image signal and a reference pixel by the correction values.

4. The projection display apparatus according to claim 1, wherein said holding means holds first and second green correction values as the correction values; and
said correcting means determines a first brightness correction value by multiplying the distance between each pixel on the left side of a central pixel of said pixels and said central pixel by the first green correction value, determines a second brightness correction value by multiplying the distance between each pixel on the right side of the central pixel and said central pixel by the second green correction value, and corrects said image signal depending on the first and second brightness correction values.

5. A brightness irregularity correcting method for a projection display apparatus including a light source that emits light, separating means that divides the light emitted from said light source into a plurality of color lights, modulators associated respectively with the color lights separated by said separating means, for modulating the color lights depending on an image signal, a prism that combines the color lights modulated respectively by said modulators, and a projection lens that projects light combined by said prism, said brightness irregularity correcting method comprising:
holding correction values for correcting brightness irregularities of the color lights which are caused by said prism, in holding means; and
in response to the image signal, determining a plurality of brightness correction values to correct the brightnesses at right and left ends of the combined light depending on the correction values held by said holding means, and correcting said image signal in order to correct each of pixels represented by said image signal depending on said brightness correction values.

6. The brightness irregularity correcting method according to claim 5, wherein said holding correction values in the holding means includes holding a correction value for red and a correction value for blue in said holding means; and
said correcting said image signal includes lowering the level of said image signal depending on a maximum value among the absolute values of the correction values held by said holding means, and correcting said image signal depending on said brightness correction values with respect to each of the correction values.

7. The projection display apparatus according to claim 2, wherein said holding means holds first and second green correction values as the correction values; and
said correcting means determines a first brightness correction value by multiplying the distance between each pixel on the left side of a central pixel of said pixels and said central pixel by the first green correction value, determines a second brightness correction value by multiplying the distance between each pixel on the right side of the central pixel and said central pixel by the second green correction value, and corrects said image signal depending on the first and second brightness correction values.

8. The projection display apparatus according to claim 3, wherein said holding means holds first and second green correction values as the correction values; and
said correcting means determines a first brightness correction value by multiplying the distance between each pixel on the left side of a central pixel of said pixels and said central pixel by the first green correction value, determines a second brightness correction value by multiplying the distance between each pixel on the right side of the central pixel and said central pixel by the second green correction value, and corrects said image signal depending on the first and second brightness correction values.
